(19) United States
(12) Patent Application Publication
(10) Pub. No.: US 2010/0126863 A1
(43) Pub. Date: May 27, 2010

(54) System and method for fully automated two dimensional gel electrophoresis

(76) Inventor: Eugene W. Stewart, JR., Sparks, NV (US)

Correspondence Address: Goodwin Procter LLP;Attn: Patent Administrator, 135 Commonwealth Drive, Menlo Park, CA, 94025-1105, US

(21) Appl. No.: 12/622,211

(22) Filed: Nov. 19, 2009

Related U.S. Application Data
(60) Provisional application No. 61/116,917, filed on Nov. 21, 2008.

(51) Int. Cl. G01N 27/447

(52) U.S. Cl. 204/457; 204/608

(57) ABSTRACT

A new approach is proposed that contemplates systems and methods to support a fully automated two dimensional gel electrophoresis instrument with modular scalability to support laboratory needs. Each instrument integrates a plurality of “plug-n-play” removable all-in-one precast “unigel” cassettes that each houses one or more of first and second dimension gels casted on a gel supports, wherein the cassette capacities of the instrument can be expanded to accommodate increasing numbers of cassettes. Here, each of the cassettes integrates a first dimension gel unit of the isoelectric focusing process and a second dimension gel unit of the polyacrylamide gel electrophoresis process and allows for automatic insertion, removal, cooling, staining and distaining of the gels as well as addition of samples and operational buffers.

### RELATED APPLICATIONS

This application claims the benefit of U.S. Application 61/116,917, filed Nov. 21, 2008, which application is fully incorporated herein by reference.

### BACKGROUND

Since mapping of the human genome, life science and drug discovery research has shifted focus to mapping cellular protein contents (proteome) as biomarkers to be used as unique drug, diagnostic targets and bio-therapeutics. There are over 220 cell types in a human body with each cell expressing potentially tens of thousands of protein variants related to health status throughout the course of the human being's life, creating a rich protein marker pool. Each newly discovered protein possesses huge commercial potential as the next new drug or diagnostic target or bio-pharmaceutical.

Two-dimensional gel electrophoresis (2DE) is an analytical technique used for the discovery of differentially expressed proteins as biomarkers which can be used for diagnostic, prognostic and therapeutic purposes. Current two-dimensional gel electrophoresis includes two complex manual operations performed sequentially-isoelectric focusing (IEF) and polyacrylamide gel electrophoresis (PAGE). Each of the two operations uses polyacrylamide gel as a sieving media through which the proteins are separated. For IEF operation, a protein sample is placed on a thin (e.g., 0.5 mm) strip of the polyacrylamide gel, where proteins are separated serially top down into protein components through an immobilized pH gradient (IPG) within the strip. Once completed, the operator carefully removes and places the strip atop a fragile slab of polyacrylamide gel where it is sealed into place for PAGE operation. This composite gel strip is then placed into another apparatus where the protein components are separated in parallel across the gel by their size into individuals. After electrophoresis, the gels are stained, scanned, and compared for protein differences.

Two-dimensional gel electrophoresis has been adopted as a primary tool and gold standard for cell protein content mapping, not because of its speed, efficiency or productivity, but because of its separating power and ability to create visual protein profile maps. Although two dimensional gel electrophoresis is capable of separating thousands of proteins from a single complex cell sample and displaying them in a visual array, the huge task to differentially map these proteins requires time and direct operation by skilled scientific staff to set up equipment and to transfer materials from apparatus to apparatus, all subject to human error. The entire process can take up to three days, limiting productivity, discovery and throughput. If done incorrectly, the results are useless, requiring repeat work and analysis at now twice the time and cost. The mechanical disadvantages driving the need for integration and automation include but are limited to:
Labor intensive and inefficient
Low throughput with poor productivity
Results can be irreproducible due to human error

These disadvantages have even driven some practitioners to adopt chromatography instead and prevent others from trying two-dimensional gel electrophoresis. The substantial commercial potential and a need to reduce drug discovery costs have created the need for genome mapping-like powerful, efficient, and automated high throughput discovery tools and chemistries.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a diagram of a fully automated two dimensional gel electrophoresis instrument.

FIG. 2 depicts an example of a diagram of an integrated precast gel cassette utilized by the two dimensional gel electrophoresis instrument depicted in FIG. 1.

FIG. 3 depicts an example of a gap junction created between the first dimension gel unit and the second dimension gel unit of the integrated gel cassette depicted in FIG. 2.

FIG. 4 depicts an example of integrated gel separation of the first dimension gel unit and the second dimension gel unit over the gap junction.

FIG. 5 depicts an example of testing of dielectric material to permit protein transfer without diffusion.

FIG. 6 depicts an example of testing of feasibility of protein components crossing over a gap junction with optimum width.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support a fully automated two dimensional gel electrophoresis instrument with modular scalability to support laboratory needs. Each instrument integrates a plurality of “plug-n-play” removable all-in-one precast “unigel” cassettes that each houses one or more of first and second dimension gels casted on a gel supports, wherein the cassette capacities of the instrument can be expanded to accommodate an increasing number of cassettes. Here, each of the cassettes integrates a first dimension gel unit for IEF operation and a second dimension gel unit for PAGE operation and allows for automatic insertion, removal, cooling, staining and distaining of the gels as well as addition of samples and operational buffers. Such an approach obsoletes current two dimensional gel electrophoresis technologies, which lacks operation automation and modular scalability. It simplifies operations, increases efficiency and throughput, while saving costs and accelerating protein discovery for scientific and medical advancement.

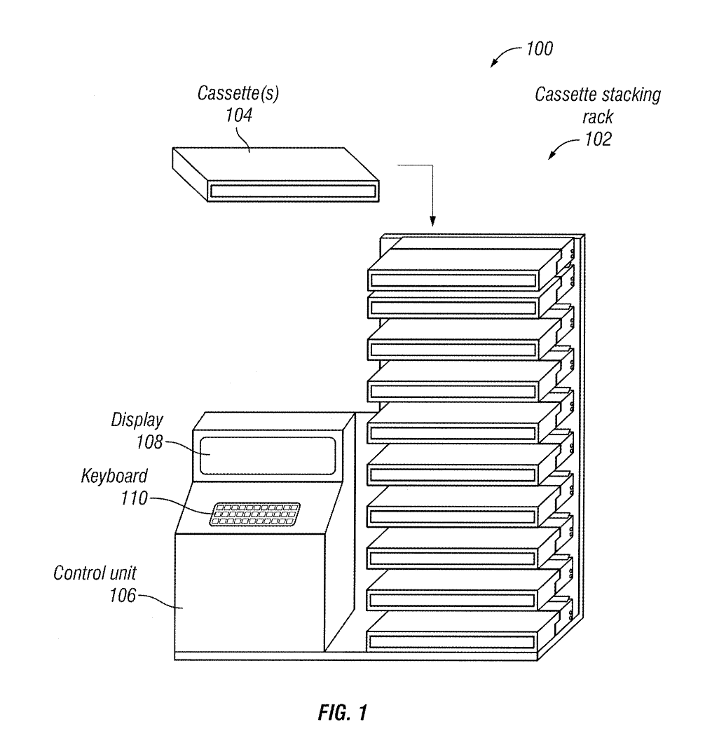

FIG. 1 depicts an example of a diagram of a fully automated two dimensional gel electrophoresis instrument. Although the diagrams depict components as functionally separate, such depiction is merely for illustrative purposes. It will be apparent that the components portrayed in this figure can be arbitrarily combined or divided into components.

In the example of FIG. 1, the instrument 100 includes a modular (vertical or horizontal) cassette stacking rack 102 operable to stack a plurality of “plug-n-play” two dimensional electrophoresis gel cassettes 104, each of which is operable to perform fully automated two dimensional electrophoresis gel separations as discussed below. Note that each of the plurality of cassettes may be operated individually with separate peripherals such as power supplies, syringe pumps, etc. Here, the cassette stacking rack 104 holds the plurality of cassettes 104 in such a way that each of the cassettes is accessible to be plugged into or pulled out of the cassette stacking rack 104 automatically by a robotic arm (not shown) for fully hand-free operation.

In some embodiments, the cassette stacking rack 102 is extensible to accommodate additional number of cassettes 104 if necessary, and the capacity of the cassette stacking rack 102 can be set dynamically to match the current laboratory load. For a non-limiting example, a first model of the cassette stacking rack 102 provides capacities ranging from fourteen cassettes 104 and up for high throughput needs of large proteome discovery labs. For another non-limiting example, a second model of the cassette stacking rack 102 provides a capacity of six cassettes 104, targeting the medium throughput needs of core support laboratories. For another non-limiting example, a third model of the cassette stacking rack 102 provides a capacity of two cassettes 104, targeting the individual research labs.

In the example of FIG. 1, the instrument 100 includes a control unit 106 for controlling and programming all operations of the instrument 100 automatically, wherein the control unit 106 may have a minimum footprint to save bench space. The control unit 106 provides a range of capabilities for monitoring and programming of experimental protocols for power, temperature, and timing controls of the instrument 100 via display unit 108 and a keyboard 110. In some embodiments, control unit 106 may further include a robotic interface (not shown) to control the operations of the robotic arm to meet the needs of pulling or plugging of cassettes 104 for very high throughput operations. Compared to manual operations, such automated control of the operations of the instrument 100 by the control unit 106 eliminates human errors in experimental results and achieves higher reproducibility, leading to increased productivity, efficiency, and discovery.

Note that instrument 100 also utilizes a plurality of electrophoresis accessory consumables to ensure optimum electrophoresis gel separation performance and results, wherein such accessory consumables include but are not limited to buffers, standard protein markers stains and sample preparation kits certified for use. A broadening line of optimized gel chemistries is developed that increase detection. In some embodiments, instrument 100 may house one or more of buffers, pumps, and valves that can be utilized to operate the instrument.

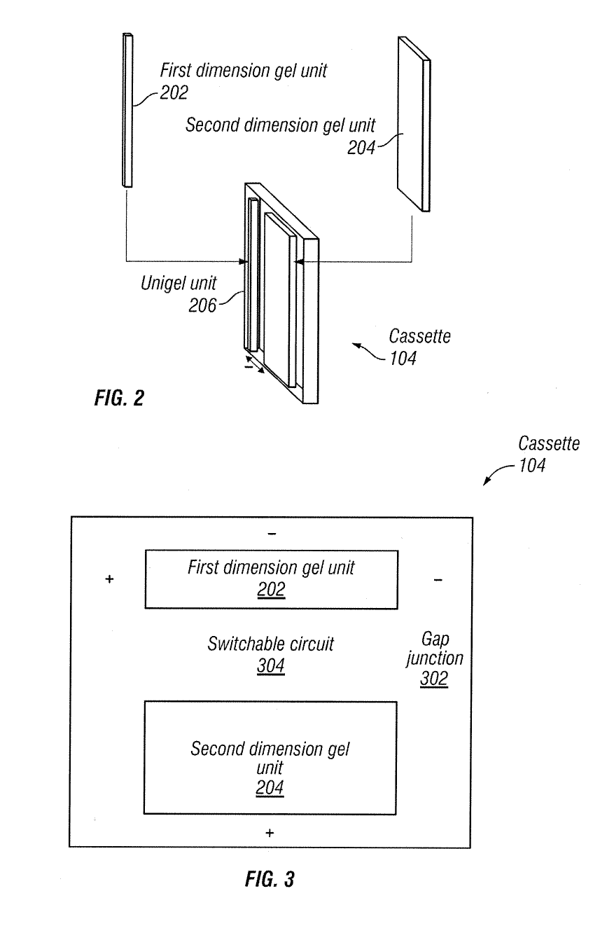

FIG. 2 depicts an example of a diagram of the integrated precast gel cassette 104 utilized by the two dimensional gel electrophoresis instrument 100. Although the diagrams depict components as functionally separate, such depiction is merely for illustrative purposes. It will be apparent that the components portrayed in this figure can be arbitrarily combined or divided into components.

As shown in the example of FIG. 2, the gel cassette 104 integrates both a first dimension IEF gel unit 202 and a second dimension PAGE gel unit 204 to enable fully automated gel separations. The integrated gel cassettes 106 so designed enable fully automated plug-n-play capabilities, yielding unattended high operation throughput via robotic interfacing with instrument 100. Here, the first dimension gel unit 202 is a thin strip of polyacrylamide gel operable to separate a protein sample into a plurality of components top down through immobilized pH gradient (IPG) within the strip via isoelectric focusing (IEF) operation, while the second dimension gel unit 204 is a slab of polyacrylamide gel operable to separate the protein components into individuals across the gel via polyacrylamide gel electrophoresis (PAGE) operation. The precast gel cassette 104 integrates the first dimension gel unit 202 and the second dimension gel unit 204 into one integrated virtual “unigel” unit 206 to the user through a series of plumbing and electrical connections. The first dimension gel unit 202 and the second dimension gel unit 204 are juxtaposed shoulder-to-shoulder as the unigel unit 206 within the cassette 104 so that the protein components can be electrically transferred out of the first dimension gel unit 202 and into the second dimension gel unit 204. The mechanical co-locations of micro thin first dimension gel unit 202 and the second dimension gel unit 204 can be achieved via one or more of laser cutting, Computer Numerically Controlled (CNC) machine operations, milling operations, vacuum forming and other techniques as needed to accommodate the precise tolerances. The gel cassette 104 can be fabricated using one or more engineering thermoplastics materials that achieve one or more of thermal conductivity, no auto-fluorescence, UV transparency, chemical compatibility, low water absorption, low surface energy or ability to be made reactive for adhesion with polyacrylamide. Such materials include but are not limited to: polyethylene terephthalate (PET) and Delrin (black, clear and glass filled), cyclic olefin copolymer (COC), acrylic, polycarbonate and polysulfone. Platinum wire can be used for electrode material and Teflon® for plumbing fittings.

In some embodiments, commercially available IEF gels (such as IPG and CA) and PAGE gels can be cast to the first dimension gel unit 202 and the second dimension gel unit 204, respectively, wherein IPG gel may be rehydrated according to manufacturing protocol and placed within the cassette 104, hermetically sealed and stored at constant temperature per manufacturers suggestions.

In the example of FIG. 2, the polyacrylamide gels are precast and sealed into gel units 202 and 204, respectively, for easy handling and time saving, since polyacrylamide gel is a flimsy gel material that is difficult to handle and can be destroyed by manual manipulation. The integrating cassette(s) 104 with the precast gels are the key component of instrument 100, allowing for automated two dimensional gel electrophoresis via sample application, insertion and removal of proprietary manufactured gels, housing of electrodes, cooling and buffers chambers and robot access.

In some embodiments, the first dimension gel unit 202 and the second dimension gel unit 204 can be separately inserted or removed from the gel cassette 104 by packaging them in individual sub-cassettes (e.g., IEF and PAGE sub-cassettes within the cassette 104), respectively. Here, an IEF sub-cassette for the first dimension gel unit 202 enables a commercial IPG strip to be inserted into a recessed (e.g., 0.2 mm) floor bed of the cassette 104 and allows for the introduction of rehydration buffer to the IPG strip, but restrains that buffer from outflow into the bordering cathode buffer and gap junctions discussed below. A ceiling may also be ported to the cassette 104 to allow for introduction of rehydration solution containing blue tracking dye. The IPG strip can be completely swelled into place against the ceiling with no spillage of rehydration buffer into cathode or the gap junctions.

In some embodiments, polyacrylamide gels in both unit 202 and 204 can be cast onto a single backing, e.g., a plastic backing known as polyacrylamide gel film (PAG), and then inserted as one piece, thereby creating a different configuration of cassette 104 with the same effect. For a cassette 104 that is leak-free and can yield even digital thermal pattern, a recessed bed can be milled into the cassette floor to accept and align both the precast PAG backed gels and the gels cast directly onto the floor, leaving them co-planar to each other and the floor of the cassette 104. Prior to casting the gels, the plastic floors/substrates can be coated with an adhesion primer for bonding of cast polyacrylamide gels to the floor substrate. Leak tests can be done visually using blue dye and cooling effectiveness can be monitored using thermal imaging during electrophoresis and/or by measuring point temperatures directly.

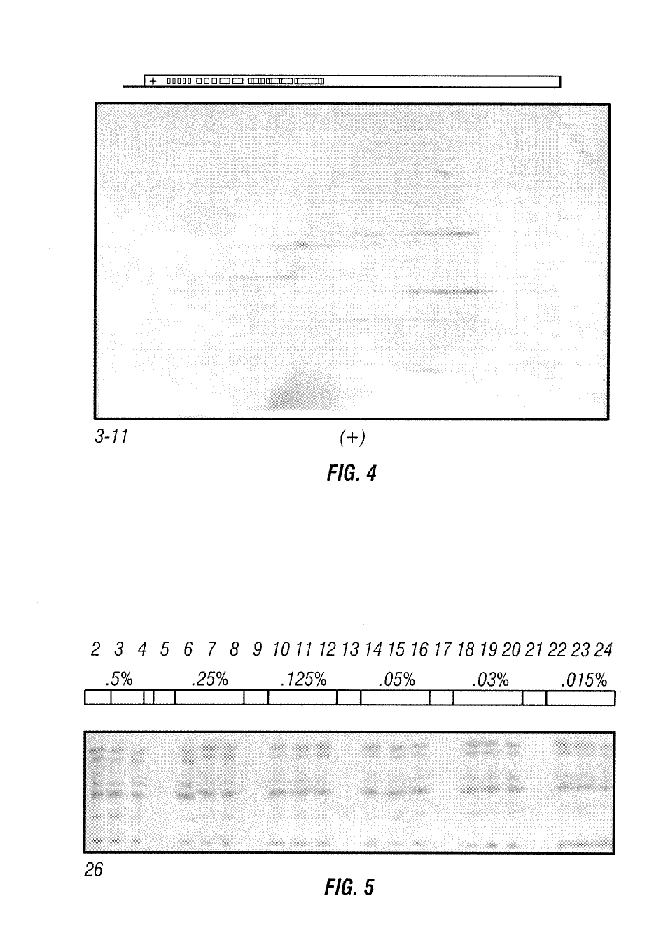

FIG. 3 depicts an example of a gap junction (channel) 302 created between the first dimension gel unit 202 and the second dimension gel unit 204 of the integrated gel cassette 104. The gap junction (channel) 302 is an enclosed channel that lies between and separates the first dimension gel unit 202 and the second dimension gel unit 204 and is partly formed by their exposed long edges. FIG. 4 depicts an example of integrated gel separation of the first dimension gel unit 202 and the second dimension gel unit 204 over a gap junction 302. A rehydrated commercial IPG strip (pH 3-10) of IEF gel unit with added two dimensional protein standard (e.g., 4,500 ng 7 proteins, 14 pls) is juxtaposed to the stacking zone of a PAGE gel unit (e.g., homogeneous, 12.5%) with 5 mm of gel removed, creating the gap junction. IEF electrode wicks are applied to the rear with the assembly covered with cellophane wrap. Air is left in the gap junction to create an open circuit and channel ends were sealed with agarose plugs. The IEF and PAGE gel units are integrated by closing the circuit, filling the gap junction with 0.25% agarose. PAGE operation is completed using buffer blocks along the cathode and anode edges and run at 200V for 5 hours. The gels are separated and silver stained. The result shows 7 to 8 MW (Molecular Weights), and 14 pl (isoelectric points) suggesting that the “gap junction” concept is feasible and integrating the first dimension gel unit 202 and the second dimension gel unit 204 into an all-in-one “unigel” unit 206 within the cassette 104 is attainable.

In some embodiments, a switchable circuit 304 can be utilized by the integrated gel cassette 104 to open or close the gap junction 302 on demand. During its operation, the switchable circuit 304 initially keeps the two gel units physically separate from each other via gap junction 302 during IEF operation on the first dimension gel unit 202 in order to prevent electrical, chemical and sample contamination between the two gel units. The switchable circuit 304 then closes gap junction 302 on demand to integrate the first dimension gel unit 202 and the second dimension gel unit 204 for optimal protein transfer during PAGE operation on the second dimension gel unit 204.

In some embodiments, the switchable circuit 304 can be an easily changeable dielectric material with switchable constants (high to low) and protein permeability injected into the gap junction 302 (which serves as a reservoir for the dielectric barrier) in order to keep the two gel units electrically and physically distinct during IEF operation, but on demand integrate them for electrical continuity and protein transfer during PAGE operation.

In some embodiments, the switchable circuit 304 may include multiple dielectric materials to function within the gap junction 302 in order to open and close the gap junction 302, at least one of high dielectric strength to open of the junction, and one of low dielectric strength to close the junction, wherein the high dielectric material is removable or allows for protein/DNA transfer or passage. For non-limiting examples, air can be used as a non-conductive high dielectric (k=1.005, breakdown strength of 3 kv/mm), and agarose solutions can be used as a conductive low dielectric with protein permeability. With air in the gap junction 302, the circuit 304 is open and IEF operation is isolated; with an agarose solution in the gap Junction 302, the circuit 304 is closed allowing for PAGE operation, protein transfer, and separation. FIG. 5 depicts an example of testing of dielectric material to permit protein transfer without diffusion. Channels 3 mm in width are cut into a precast polyacrylamide gel to simulate the gap junction 302. Agarose is serially diluted and pipetted back into each of the channels. Two dimensional gel electrophoresis protein standards (e.g., Biorad, 7 proteins) are added into the numbered sample wells and PAGE operation is run at 200V for 5 hrs with gels silver stained. Seven bands are visible with 0.5% to 0.125% agarose, indicating that agarose is a feasible material.

In the example of FIG. 3, width of the gap junction 302 between the first dimension gel unit 202 and the second dimension gel unit 204 is adjustable, and an optimum width of the gap junction 302 can be chosen to prevent electrical disturbances to the second dimension gel unit 204 during IEF operation on the first dimension gel unit 202. Such breakdown in dielectric strength and shorting between the gel units may be due to the enclosed, hydrated precast gels that cause a rise in the relative humidity in the gap junction 302. For experimental purposes, high voltage power supply between 2-10 kV can be applied across the first dimension gel unit 202 while widths of the gap junction 302 are sequentially increased by 1 mm increment, for non-limiting examples, 3, 5, and 7 mm, in order to determine the optimum width for electrical disturbance prevention. Optimal width of the gap junction 302 or dielectric thickness is determined by the distance at which there is no arching (breakdown) between the first and the second dimension gel units.

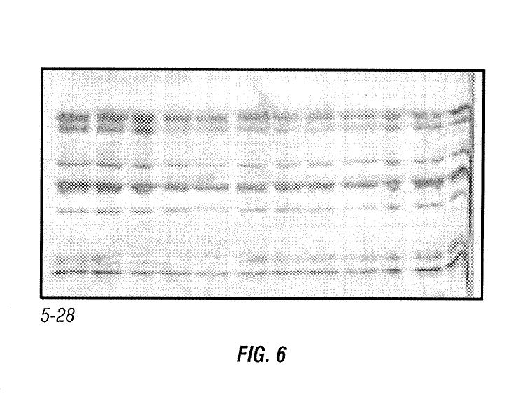

In the example of FIG. 3, an optimum width of the gap junction 302 between the first dimension gel unit 202 and the second dimension gel unit 204 can be chosen to allow the protein components to migrate to the second dimension gel unit 204 unchanged during PAGE operation on the second dimension gel unit 204. For experimental purposes, a PAGE gel unit can be cut into two pieces, creating a simple channel of varying width (e.g., 3, 5, and 7 mm) running the entire width of the gel unit. The channel can then be filled with various solutions of test transfer media (dielectric material) to determine optimum width for protein migration. FIG. 6 depicts an example of testing of feasibility of protein components crossing over a gap junction with optimum width. A gap junction 302 was created by cutting along the interface of the stacking of a precast PAGE gel and separating the two zones at the optimal width of 5 mm. The ends of the gap junction 302 were sealed with agarose plugs, and the gel re-integrated by backfilling with a 0.25% agarose solution. Two dimensional gel electrophoresis protein standards (e.g., Biorad, 7 proteins) were serially diluted and placed in triplicate into the preformed sample wells and the PAGE operation runs at 200V for 5 hours, with the gel was silver stained. Results show all seven proteins distinctly and evenly separated with no significant cross lane contamination.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

Expected variations or differences in the results are contemplated in accordance with the objects and practices of the present invention. It is intended, therefore, that the invention be defined by the scope of the claims which follow and that such claims be interpreted as broadly as is reasonable.

1. A two dimensional gel electrophoresis instrument, comprising:
a plurality of “plug-n-play” two dimensional electrophoresis gel cassettes, wherein each of the plurality of cassettes performs fully automated two dimensional electrophoresis gel separations;
a modular cassette stacking rack, which in operation, holds the plurality of “plug-n-play” two dimensional gel electrophoresis cassettes in such a way that each of the plurality of cassettes is accessible to be plugged into or pulled out of the cassette stacking rack automatically by a robotic arm for fully hand-free operation;
a control unit which in operation, controls and programs all operations of the instrument automatically.

2. The instrument of claim 1, wherein:
the cassette stacking rack is extensible to accommodate additional number of the plurality of cassettes to match current laboratory load.

3. The instrument of claim 1, wherein:
the control unit has a minimum footprint to save bench space.

4. The instrument of claim 1, wherein:
the control unit further comprises a robotic interface to control operations of the robotic arm to plug in or pull out the plurality of cassettes for very high throughput operations.

5. The instrument of claim 1, wherein:
the instrument utilizes a plurality of electrophoresis accessory consumables to ensure optimum electrophoresis gel separation performance and results.

6. An integrated gel cassette, comprising:
a first dimension gel unit, wherein the first dimension gel unit is a thin strip of polyacrylamide gel operable to separate a protein sample into a plurality of protein components top down through immobilized pH gradient (IPG) within the strip via isoelectric focusing (IEF) operation;
a second dimension gel unit, wherein the first dimension gel unit is a slab of polyacrylamide gel operable to separate the plurality of protein components into a plurality of protein individuals across the gel via polyacrylamide gel electrophoresis (PAGE) operation;
wherein the first dimension gel unit and the second dimension gel unit are juxtaposed shoulder-to-shoulder separated by a gap junction as an integrated unigel unit within the cassette so that the plurality of protein components can be electrically transferred out of the first dimension gel unit and into the second dimension gel unit.

7. The cassette of claim 6, wherein:
the gel cassette is fabricated using one or more engineering thermoplastics materials.

8. The cassette of claim 6, wherein:
the integrated gel cassette enables fully plug-n-play via an two dimensional gel electrophoresis instrument, yielding unattended high operation throughput.

9. The cassette of claim 6, wherein:
the polyacrylamide gel of the first dimension gel unit is rehydrated according to manufacturing protocol and placed within the cassette, hermetically sealed and stored at constant temperature to allow humidity to reach a steady state.

10. The cassette of claim 6, wherein:
the polyacrylamide gels are precast and sealed into the first dimension gel unit and the second dimension gel unit, respectively.

11. The cassette of claim 6, wherein:
the first dimension gel unit and the second dimension gel unit are separately inserted/removed from the gel cassette by packaging them in individual sub-cassettes.

12. The cassette of claim 6, wherein:
the polyacrylamide gels in both the first dimension gel unit and the second dimension gel unit are cast onto a single backing and then inserted as one piece.

13. The cassette of claim 6, wherein:
the gap junction is an enclosed channel that lies between and separates the first dimension gel unit and the second dimension gel unit and is partly formed by their exposed long edges.

14. The cassette of claim 6, further comprising:
a switchable circuit operable to open or close the gap junction on demand.

15. The cassette of claim 14, wherein:
the switchable circuit initially keeps the first dimension gel unit and the second dimension gel unit physically separate from each other via the gap junction during IEF operation in order to prevent electrical, chemical and sample contamination between the two gel units.

16. The cassette of claim 14, wherein:
the switchable circuit closes the gap junction on demand to integrate the first dimension gel unit and the second dimension gel unit for optimal protein transfer during PAGE operation.

17. The cassette of claim 14, wherein:
the switchable circuit is an easily changeable dielectric material injected into the gap junction with switchable constants and protein permeability.

18. The cassette of claim 14, wherein:
the switchable circuit includes at least one dielectric material of high dielectric strength to open of the junction to prevent electrical disturbances, and one dielectric material of low dielectric strength to close the junction, allowing for protein transfer.

19. The cassette of claim 18, wherein:
the dielectric material of high dielectric strength is air or other material of high dielectric strength which is removable and/or allows for protein transfer.

20. The cassette of claim 18, wherein:
the dielectric material of low dielectric strength is agarose (or others)

21. The cassette of claim 13, wherein:
width of the gap junction between the first dimension gel unit and the second dimension gel unit is adjustable.

22. The cassette of claim 21, wherein:
an optimum width of the gap junction is chosen to prevent electrical disturbances to the second dimension gel unit during IEF operation on the first dimension gel unit.

23. The cassette of claim 21, wherein:
an optimum width of the gap junction is chosen to allow the protein components to migrate to the second dimension gel unit unchanged during PAGE operation on the second dimension gel unit.

24. A method for two dimensional gel electrophoresis, comprising:
holding a plurality of “plug-n-play” two dimensional gel electrophoresis cassettes in a cassette stacking rack;
plugging in or pulling out each of the plurality of cassettes from the cassette stacking rack automatically via a robotic arm for fully hand-free operation;
performing fully automated two dimensional electrophoresis gel separations via each of the plurality of cassettes, wherein each of the plurality of cassettes;
controlling and programming all operations during the two dimensional electrophoresis gel separations automatically.

25. The method of claim 24, further comprising:
expanding the cassette stacking rack to accommodate additional number of the plurality of cassettes to match current laboratory load.

26. The method of claim 24, further comprising:
controlling operations of the robotic arm to plug in or pull out the plurality of cassettes for very high throughput operations.

27. The method of claim 24, further comprising:
utilizing a plurality of electrophoresis accessory consumables to ensure optimum electrophoresis gel separation performance and results.

28. An method for integrated gel separation, comprising:
separating a protein sample into a plurality of protein components top down through immobilized pH gradient (IPG) within the strip via isoelectric focusing (IEF) operation via a first dimension gel unit;
separating the plurality of protein components into a plurality of protein individuals across the gel via polyacrylamide gel electrophoresis (PAGE) operation via a second dimension gel unit;
integrating the first dimension gel unit and the second dimension gel unit as an integrated unigel unit within a gel cassette so that the plurality of protein components can be electrically transferred out of the first dimension gel unit and into the second dimension gel unit.

29. The method of claim 28, further comprising:
fabricating the gel cassette using one or more engineering thermoplastics materials.

30. The method of claim 28, further comprising:
enabling fully plug-n-play and yielding unattended high operation throughput via an two dimensional gel electrophoresis instrument.

31. The method of claim 28, further comprising:
rehydrating the polyacrylamide gel of the first dimension gel unit according to manufacturing protocol and placing it within the cassette, hermetically sealed and stored at constant temperature to allow humidity to reach a steady state.

32. The method of claim 28, further comprising:
precasting and sealing the polyacrylamide gels into the first dimension gel unit and the second dimension gel unit, respectively.

33. The method of claim 28, further comprising:
inserting/removing the first dimension gel unit and the second dimension gel unit separately from the gel cassette by packaging them in individual sub-cassettes.

34. The method of claim 28, further comprising:
casting the polyacrylamide gels in both the first dimension gel unit and the second dimension gel unit onto a single backing and then inserting it as one piece.

35. The method of claim 28, further comprising:
creating a gap junction between the first dimension gel unit and the second dimension gel unit, wherein the gap junction is an enclosed channel that lies between and separates the first dimension gel unit and the second dimension gel unit and is partly formed by their exposed long edges.

36. The method of claim 35, further comprising:
opening or closing the gap junction on demand.

37. The method of claim 36, further comprising:
keeping the first dimension gel unit and the second dimension gel unit physically separate from each other via the gap junction during IEF operation in order to prevent electrical, chemical and sample contamination between the two gel units.

38. The method of claim 36, further comprising:
closing the gap junction on demand to integrate the first dimension gel unit and the second dimension gel unit for optimal protein transfer during PAGE operation.

39. The method of claim 35, further comprising:
injecting an easily changeable dielectric barrier into the gap junction with switchable constants and protein permeability.

40. The method of claim 35, further comprising:
utilizing one dielectric material of high dielectric strength to open of the junction to prevent electrical disturbances, and one dielectric material of low dielectric strength to close the junction, allowing for protein transfer.

41. The method of claim 28, further comprising:
adjusting width of the gap junction between the first dimension gel unit and the second dimension gel unit.

42. The method of claim 41, further comprising:
determining an optimum width of the gap junction to prevent electrical disturbances to the second dimension gel unit during IEF operation on the first dimension gel unit.

43. The method of claim 41, further comprising:
determining an optimum width of the gap junction to allow the protein components to migrate to the second dimension gel unit unchanged during PAGE operation on the second dimension gel unit.
